(19) United States
(12) Patent Application Publication
(10) Pub. No.: US 2024/0276080 A1
(43) Pub. Date: Aug. 15, 2024

(54) INFRARED IMAGING DEVICE

(71) Applicant: LYNRED, PALAISEAU (FR)

(72) Inventors: Gabriel JOBERT, VEUREY-VOROIZE (FR); Xavier BRENIERE, VEUREY-VOROIZE (FR); Alexia GORECKI, VEUREY-VOROIZE (FR); Alexandre BRUNNER, VEUREY-VOROIZE (FR)

(21) Appl. No.: 18/692,140

(22) PCT Filed: Sep. 23, 2022
(86) PCT No.: PCT/EP2022/076509

§ 371 Date: Mar. 14, 2024

(30) Foreign Application Priority Data
Sep. 24, 2021 (FR) FR2110092

(51) Int. Cl. H04N 23/23; H04N 23/52; H04N 23/55

(52) U.S. Cl. CPC H04N 23/23; H04N 23/52; H04N 23/55

(57) ABSTRACT

The present description concerns an infrared imaging device (200) comprising an infrared camera (210) having an optical axis (A) and intended to detect an infrared radiation in a spectral range through an element (132) transparent to said infrared radiation, said transparent element being surrounded by a mount (134), the transparent element with the mount being adapted to being inserted in an opening of a wall (130), the transparent element and the wall being inclined by an angle of inclination (a) greater than 0° and smaller than 90° or smaller than 0° and greater than −90° with respect to the optical axis (A) of the infrared camera; the device further comprising:
an interface element (230) adapted to forming an interface between the infrared camera (210) and the mount (134).

### TECHNICAL FIELD

The present disclosure generally concerns the field of infrared imaging and concerns in particular an infrared camera in which an image is detected by said infrared camera through a porthole transparent to infrared radiation.

### PRIOR ART

In the field of infrared imaging, an infrared camera (“IR camera”), adapted to capturing thermal images of a scene, may be used. An IR camera generally comprises an arrangement of infrared-sensitive detectors forming an array of pixels. Each pixel of the pixel array converts a temperature measured at the pixel into a corresponding voltage signal, which is converted by a digital-to-analog converter (ADC) into a digital output signal. A microbolometer is an example of a pixel used for an uncooled infrared pixel array camera, adapted to capturing thermal images of an image scene.

In certain applications, an IR camera may be positioned within an enclosure, or at least arranged behind a wall, so that the radiation is detected by the IR camera through the wall. This wall may be inclined at a non-zero angle with respect to the vertical direction. When the material of the wall is not transparent to IR radiation, the wall is provided with an element transparent to IR radiation, for example a porthole, this porthole being positioned so that the IR camera can receive the IR radiation through said porthole. Generally, such a porthole has the smallest possible lateral dimensions.

However, when the wall is inclined, so is the porthole. The presence of an inclined porthole having small lateral dimensions may generate an undesired vignetting phenomenon on the image captured by the IR camera, that is, a decrease in the brightness on the edges of the image (in other words, an increase in the opacity on the edges of the image). This phenomenon may worsen as the distance between the porthole and the IR camera increases.

### SUMMARY OF THE INVENTION

There exists a need to control the vignetting phenomenon for an infrared camera intended to be positioned behind a wall.

An embodiment overcomes all or part of the above-mentioned disadvantages.

An embodiment provides an infrared imaging device comprising an infrared camera having an optical axis and intended to detect an infrared radiation in a spectral range through an element transparent to said infrared radiation, said transparent element being surrounded by a mount, the transparent element with the mount being adapted to being inserted in an opening of a wall, the transparent element and at least a portion of the wall having the transparent element inserted therein being inclined by an angle of inclination greater than 0° and smaller than 90° or smaller than 0° and greater than −90° with respect to the optical axis of the infrared camera; the device further comprising:
an interface element adapted to forming an interface between the infrared camera and the mount.

The transparent element comprises two surfaces, an entrance surface and an exit surface, preferably substantially planar and parallel to each other.

The transparent element is preferably included in the volume freed by the opening of the wall, that is, the volume corresponding to the opening of the wall. For example, the transparent element does not laterally protrude on either side of the opening.

Preferably, the wall is also inclined by the angle of inclination around the opening. For example, the wall is fully inclined by the angle of inclination.

According to an embodiment, at least one inner surface of the interface element is shaped in such a way as to decrease the emission of infrared radiation by said interface element towards the camera.

According to an embodiment, at least one inner surface of the interface element is made of a material adapted to decreasing the emission of infrared radiation by said interface element towards the camera.

According to an embodiment, at least one inner surface of the interface element is covered with a coating adapted to decreasing the emission of infrared radiation by said interface element towards the camera.

According to an embodiment, the interface element comprises a first end adapted to engaging with the mount of the transparent element, for example by shape complementarity with said mount.

According to an embodiment, the interface element comprises a second end adapted to engaging with the infrared camera, for example by shape complementarity with at least part of said infrared camera.

According to an embodiment, the interface element comprises a first end shaped to engage with the mount and a second end shaped to engage with the camera. For example, the interface element comprises a body between the first and the second end.

According to an embodiment, the interface element is formed of two parts assembled on either side of the infrared camera. According to a specific embodiment, the interface element is in one piece.

According to an embodiment, the interface element has a hollow shape.

According to an embodiment, the infrared camera comprises at least one lens and a lens mount, said at least one lens being held by said lens mount, the second end of the interface element being adapted to engaging with the lens mount, for example by shape complementarity with said lens mount. According to an example, the lens mount at least partially surrounds the at least one lens.

According to another embodiment, the infrared camera comprises at least one lens and a lens mount, said at least one lens being held by said lens mount, the interface element and the lens mount forming one piece. According to an example, the lens mount at least partially surrounds the at least one lens.

According to another embodiment, the infrared camera comprises at least one lens and a lens mount, said at least one lens being held by said lens mount, at least one lens and/or the lens mount comprising a truncated surface adapted to being positioned in front of the wall. According to an example, the lens mount at least partially surrounds the at least one lens.

According to an example, the truncation angle of the truncated surface with respect to the optical axis of the infrared camera is substantially equal to the angle of inclination of the wall portion and of the transparent element.

According to an example, the interface element comprises at least a portion adapted to covering the truncated surface, said portion forming, for example, a thermal protection of the truncated surface and/or a protection of said truncated surface from infrared radiation.

According to an embodiment, the infrared camera comprises:
at least one lens and a lens mount, said at least one lens being held by said lens mount; and
an image sensor sensitive to the infrared radiation of the spectral range; the sensor and the at least one lens defining the optical axis of the infrared camera, the sensor being arranged substantially in the image focal plane of said at least one lens. According to an example, the lens mount at least partially surrounds the at least one lens.

According to an embodiment, the interface element is adapted to achieving a fluid-tight assembly between the wall and the infrared camera.

According to an embodiment, the interface element is made of a material having a low thermal conduction, for example a thermal conduction lower than 10 W·m⁻¹·K⁻¹.

According to an embodiment, the interface element is provided with at least one temperature probe, at least one temperature probe being for example coupled to a module for processing a stray light flux, for example a stray light flux emitted by the device.

According to an embodiment, the device comprises a removable shutter element adapted to shut off the infrared camera. According to an example, the shutter element is covered with an emissive coating on a surface of said shutter element located in front of the infrared camera.

According to an embodiment, the interface element comprises an inner emitting surface facing the infrared camera and adapted to being positioned close to the transparent element, for example against the mount of the transparent element. According to an example, said inner emitting surface is covered with an emissive coating.

According to an embodiment, the interface element comprises a portion adapted to being positioned in front of a region of the transparent element, for example an edge of said transparent element, so as to form a screen between said region of the transparent element and the infrared camera, said portion comprising an emitting surface facing the infrared camera. According to an example, said emitting surface is covered with an emissive coating.

According to an embodiment, the infrared camera comprises an image sensor with a pixel array comprising an angular pixel adapted to capturing a light flux originating from an inner area of the interface element facing the image sensor and the field of view of the angular pixel, for example an inner area intended to be positioned around the transparent element. According to an example, said inner area is covered with an emissive coating.

An embodiment provides an infrared imaging system comprising:
an infrared imaging device according to an embodiment, and
a wall comprising an opening having an element transparent to the infrared radiation of a spectral range, surrounded by a mount, inserted therein;
the infrared camera of the device being adapted to detecting an infrared radiation of the spectral range through the transparent element;
the transparent element and at least a portion of the wall having the transparent element inserted therein being inclined by an angle of inclination greater than 0° and smaller than 90° or smaller than 0° and greater than −90° with respect to the optical axis of the camera.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1A, and

FIG. 1B are cross-section views of an example of an infrared camera positioned behind an inclined wall;

FIG. 2A is a cross-section view of an example of an infrared imaging device according to an embodiment;

FIG. 2B is a cross-section view of a variant of the example of infrared imaging device of FIG. 2A;

FIG. 2C is a cross-section view of another variant of the example of infrared imaging device of FIG. 2A;

FIG. 2D is a cross-section view of another variant of the example of infrared imaging device of FIG. 2A;

FIG. 3A is a cross-section view of a variant of an infrared camera;

FIG. 3B is a cross-section view of another variant of an infrared camera;

FIG. 4 is a cross-section view of another example of an infrared imaging device according to an embodiment.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the optics, for example the lenses and their mount, and the image sensor, for example the array image sensor in the form of an array of microbolometers or of an array of photodiodes, are not detailed, being known by those skilled in the art in the field of the invention.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings or to an IR imaging device in a normal position of use.

When reference is made to the terms “in front of/behind” or “front/back”, reference is made to the direction of propagation of the light rays/radiation, that is, from the transparent element to the infrared camera.

When reference is made to angle values, it must be understood that these values are given in the trigonometric direction, represented by the quarter-circle arrow with the “+” sign in the drawings. A negative angle value thus corresponds to an angle in a clockwise direction.

Unless specified otherwise, the expressions “about”, “approximately”, “substantially”, and “in the order of” signify plus or minus 10%, preferably of plus or minus 5%.

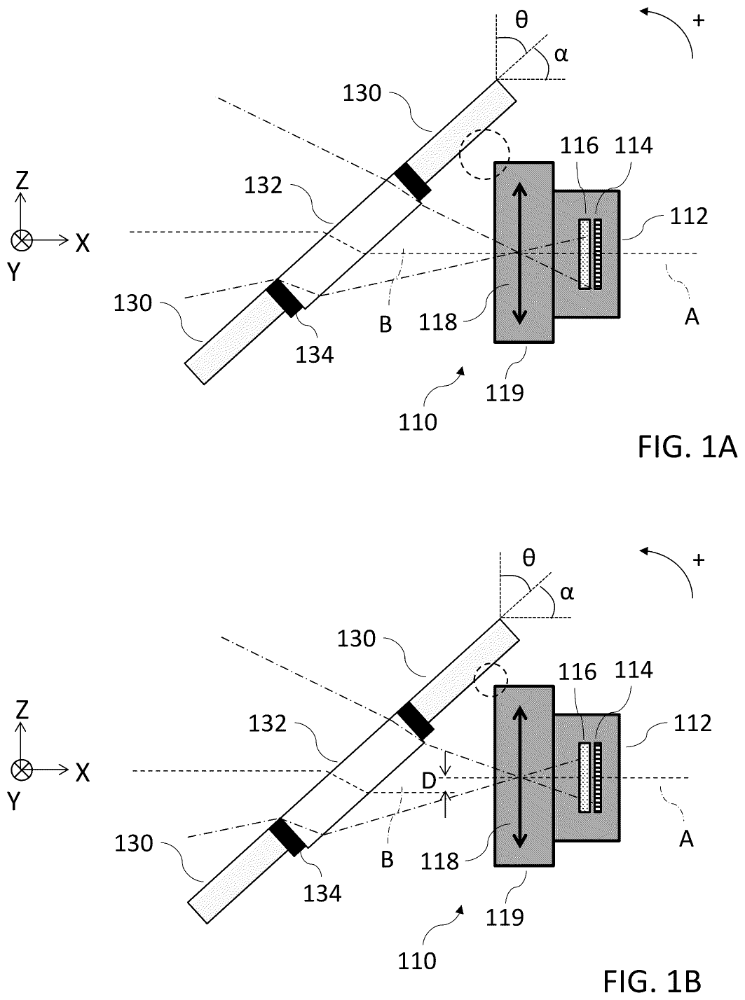

An example of an infrared (IR) camera is shown in FIGS. 1A and 1B. Infrared camera 110 comprises a housing 112 containing an image sensor 114 sensitive to infrared radiation, as well as a window 116 located in front of image sensor 114 and capable of transmitting the IR radiation in the spectral range of use of the IR camera. Advantageously, the image sensor is an array image sensor formed of an array of microbolometers. Alternatively, the image sensor is an array image sensor formed of an array of photodiodes based on semiconductor materials.

The IR camera further comprises a plurality of lenses 118 (only one has been shown but there is usually a plurality) capable of operating in the spectral range of use of the camera so as to form an image on the image sensor (the camera is in the image focal plane of the lenses), the lenses being held in a lens mount 119 assembled to housing 112. Lens mount 119 is positioned so that window 116 is located between said mount and image sensor 114. The sensor and the lenses define the optical axis A of the camera. In the shown example, the optical axis is in the horizontal direction X.

IR camera 110 may be positioned in an enclosure, or at least be arranged behind a wall 130, so that the radiation is detected by the IR camera through the wall. Such an enclosure or wall may fulfil a function of mechanical and/or thermal protection for the camera, and/or a function of protection of the camera from the environment, and/or an aerodynamic function, and/or a function of protection of a user (for example, a shield, in particular a windscreen), or even an aesthetic function (for example to mask the camera).

Wall 130 may be a planar wall, as shown. Alternatively, it may locally comprise, in the vicinity of the camera, at least one planar wall portion.

The wall may be non-transparent to IR radiation, it may be unsuitable for transmitting an image, for example it may be rough or diffusive, or it may not transmit IR radiation with a sufficient quality in the spectral range of use of the IR camera, which is for example between 1 and 20 μm, preferably between 8 and 14 μm, or even between 8 and 12 μm. In this case, a porthole 132 transparent to IR radiation in the spectral range of use of the IR camera may be inserted in an opening in the wall. Porthole 132 may, for example, be inserted in the wall by means of a porthole mount 134.

Porthole 132 is adapted to transmitting IR radiation to IR camera 110. For example, the porthole may be formed from a plate made of zinc sulfide (ZnS), zinc selenide (ZnSe), silicon (Si), germanium (Ge), barium fluoride (BaF₂), calcium fluoride (CaF₂), sapphire, chalcogenide glass, or any other material transparent to IR radiation in the spectral range of use of the IR camera.

Porthole 132 is characterized by two substantially parallel surfaces having a given surface area of occupancy (called “pupil”), the two surfaces being separated by a distance (thickness). The dimensions of the two surfaces (pupil dimensions) are, for example, in the order of one centimeter, or of some ten centimeters, with a thickness in the order of a few millimeters.

In certain applications, wall 130 and porthole 132 may be inclined by an angle θ with respect to the focal plane of the lenses (in the shown example, the focal plane is parallel to the vertical plane YZ having its vertical direction Z shown in the cross-section views), between 0 and 90°, and more specifically between 30° and 70°, for example around 60°. In other words, wall 130 and porthole 132 may be inclined by an angle α with respect to optical axis A, which is shown in horizontal direction X. Angle α is complementary to angle θ, and thus between 0 and 90°, and more specifically between 20° and 60°, for example around 30°.

Further, it is sometimes desired for the pupil of the porthole to be as small as possible. Indeed, since the surface area occupied by the wall is decreased by the surface area occupied by the porthole and possibly by the porthole mount, this decreases the ability of the wall to fulfil its function, for example its protective or aesthetic function. Further, increasing the pupil of the porthole may alter the mechanical integrity of the wall. Further, the material used to form the porthole pupil has a non-negligible cost, which is desired to be decreased by decreasing the pupil and, to a lesser extent, its thickness.

However, the decrease of the porthole pupil when the latter is inclined has the consequence and disadvantage of limiting the field of view of the IR camera (known as “FOV”), causing a vignetting phenomenon, since the rays at the ends of the field of view are cut off by the edge of the porthole. In particular, the vertical field of view (“VFOV”) may be degraded with respect to the horizontal field of view (“HFOV”) due to the inclination of the porthole.

The vignetting phenomenon worsens as the distance between the porthole and the IR camera increases. Thus, it is advantageous to position the IR camera as close as possible to the porthole, within the limit of the spacing between IR camera 110 and wall 130 (this limit is marked by the dotted circles in FIGS. 1A and 1B). This spacing is all the smaller as the angle of inclination θ with respect to the vertical direction is significant.

Further, if the optical axis A of IR camera 110 is centered on the refracted optical axis B of porthole 132, that is, the optical axis after deflection by refraction effect in said porthole, as illustrated in FIG. 1A, then the IR camera may exhibit an asymmetrical vertical vignetting, for example a vignetting favoring the upper part of the vertical field of view. A symmetrical vignetting can be achieved by vertically off-centering by a distance D the optical axis A of IR camera 110 with respect to the refracted optical axis B of porthole 132, as shown in FIG. 1B (although this results in further decreasing the spacing between the IR camera and the wall, as can be seen by comparing FIGS. 1A and 1B).

There thus exists a need to accurately position an infrared camera with respect to an inclined porthole in order to control the vignetting phenomenon. Further, in certain applications, for example where the IR camera may be subject to accelerations and/or shocks, it would be advantageous to be able to safely maintain and control the positioning even in the event of an acceleration and/or of a shock. In other words, there exists a need to accurately, and preferably robustly, position an IR camera with respect to an inclined porthole.

The inventors provide an infrared imaging device enabling to address these needs.

Examples of infrared imaging devices will be described hereafter. These examples are non-limiting and different variants will occur to those skilled in the art based on the indications of the present description.

The infrared domain is characterized by a spectral range comprising wavelengths from 1 μm to 20 μm.

Advantageously, the infrared camera and the imaging device according to an embodiment are adapted to operating in a spectral range comprised in the long-wave infrared domain (“LWIR”) which is a spectral range extending between 8 μm and 12 μm.

According to another example, the infrared camera and the imaging device according to an embodiment are adapted to operating in a spectral range comprised in the short-wave infrared (“SWIR”) domain, which is a spectral range extending between 1 μm and 2.5 μm.

According to another example, the infrared camera and the imaging device according to an embodiment are adapted to operating in a spectral range comprised in the medium-wave infrared (MWIR) range, which is a spectral range extending between 3 μm and 5 μm.

According to another example, the infrared camera and the imaging device according to an embodiment are adapted to operating in a spectral range comprised in the very long-wave infrared (VLWIR) domain, which is a spectral range extending between 12 μm and 22 μm.

Of course, the infrared camera and the device can be adapted to operating in a spectral range extending in a plurality of the previously-mentioned ranges.

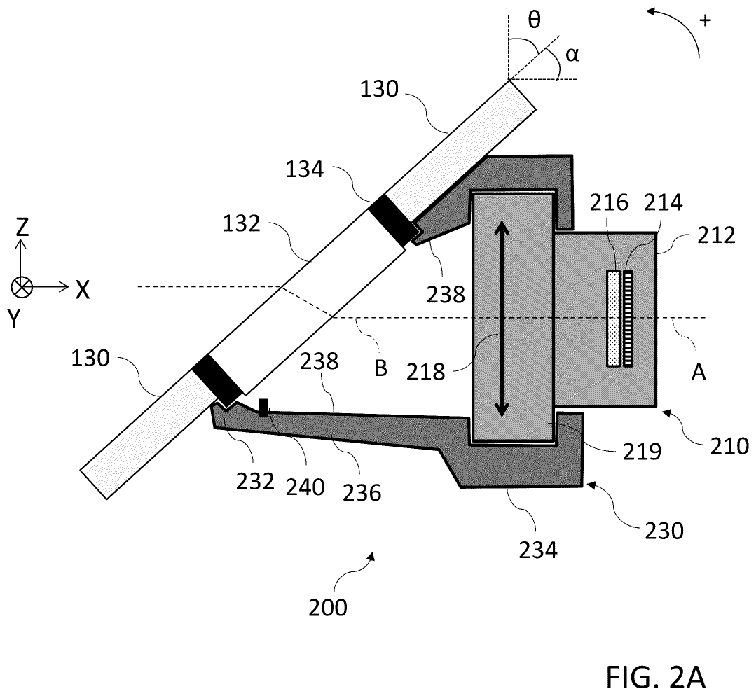

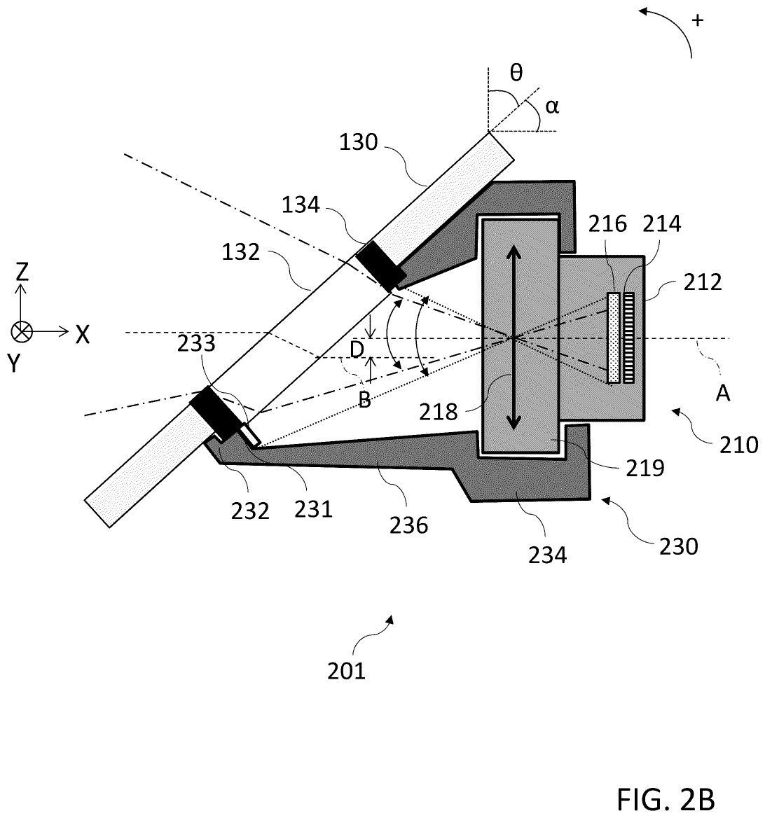

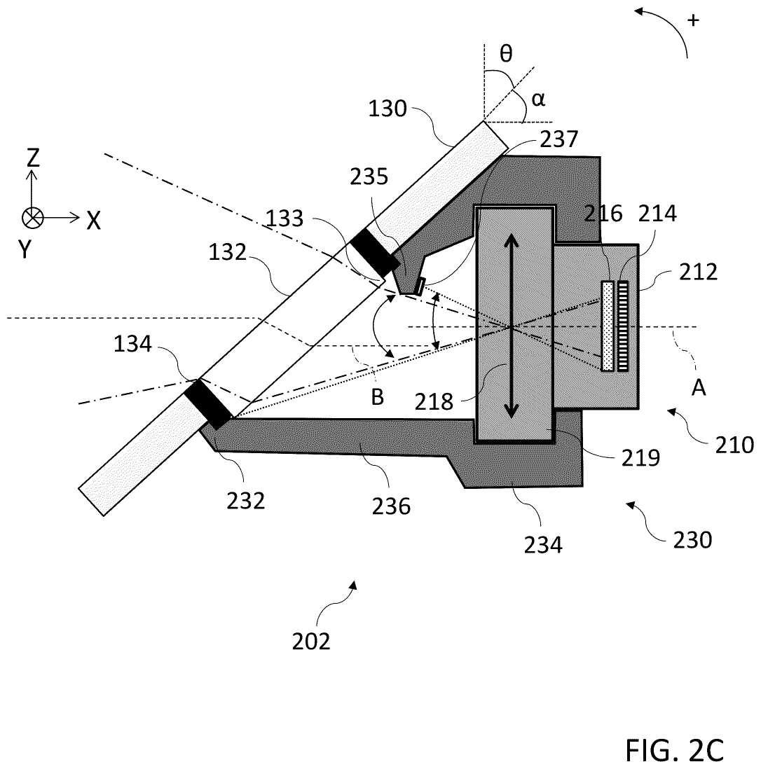

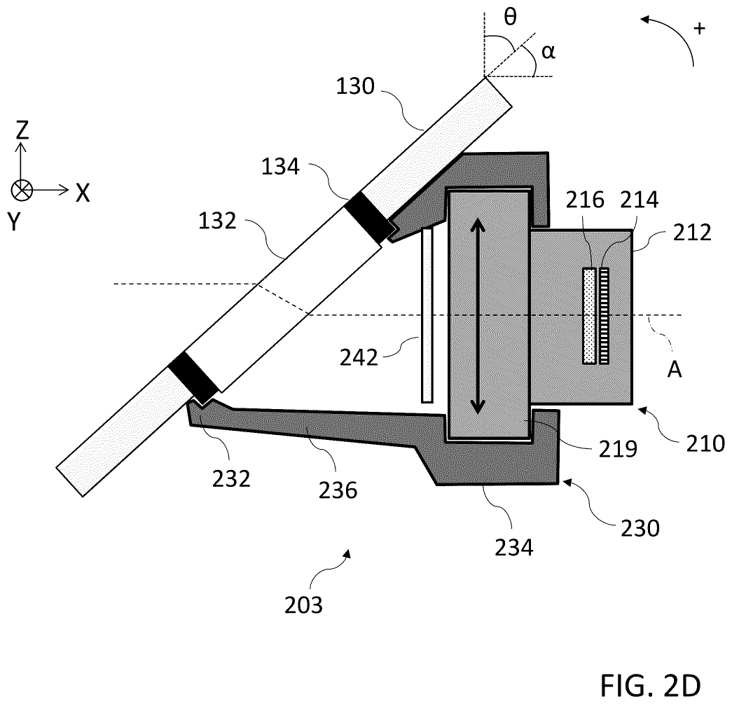

FIG. 2A is a cross-section view of an example of an IR imaging device according to an embodiment, comprising an infrared camera 210 shown behind a wall 130 (where the wall does not form part of the device).

Similarly to the infrared camera 110 described in relation with FIGS. 1A and 1B, infrared camera 210 comprises a housing 212 containing an image sensor 214 sensitive to infrared radiation, as well as a window 216 located in front of image sensor 214 and capable of transmitting IR radiation in the spectral range of use of the IR camera. The image sensor advantageously is an array image sensor comprising an array of microbolometers. Alternatively, the image sensor is an array image sensor comprising an array of photodiodes based on semiconductor materials.

The IR camera further comprises a plurality of lenses 218 capable of operating in the spectral range of use of the camera so as to form an image on the image sensor, the camera being in the image focal plane of the lenses. The lenses are held in a lens mount 219 assembled to housing 212, the lens mount 219 being positioned so that window 216 is arranged between said mount and sensor 214. The sensor and the lenses define the optical axis A of the camera, shown in horizontal direction X.

Wall 130 is similar to the wall shown in FIGS. 1A and 1B. Thus, it comprises a porthole 132 (also called “transparent element”), the porthole being transparent to infrared radiation in the spectral range of use of the IR camera. Porthole 132 is inserted with a porthole mount 134 in an opening in the wall 130. The wall may be a shield, for example a windscreen. The wall may be a wall of an enclosure, for example a closed enclosure, in particular a closed enclosure capable of being thermally regulated.

For example, the porthole may be formed from a plate made of zinc sulfide (ZnS), zinc selenide (ZnSe), silicon (Si), germanium (Ge), barium fluoride (BaF₂), calcium fluoride (CaF₂), sapphire, chalcogenide glass or any other material transparent to IR radiation in the spectral range of use of the IR camera.

Wall 130 and porthole 132 are inclined by an angle α with respect to optical axis A, which is shown in horizontal direction X. The angle of inclination α is between 0 and 90°, and more specifically between 20° and 60°, for example around 30°.

The infrared camera is adapted to capturing a thermal image of an image scene through the inclined porthole.

The IR imaging device further comprises an interface element 230 positioned between infrared camera 210 and porthole mount 134. Interface element 230 is adapted to forming an interface between the IR camera and the porthole mount, and this, in order to allow a relative positioning of the device with respect to the transparent element.

The shown interface element 230 is a rigid, one-piece element having a substantially oblique and hollow conical frustum shape, adapted to coupling IR camera 210 and mount 134. The shown interface element 230 comprises:
a first end 232 shaped to engage with porthole mount 134 by shape complementarity with said mount, thus assembling to the wall all around the porthole;
a second end 234 shaped to engage with lens mount 219 by shape complementarity with said lens mount;
a body 236 between the first and the second end.

Body 236 forms an envelope which is preferably opaque to the light radiation in a given spectral range. Said envelope is thus preferably adapted to blocking all or part of stray light rays coming from behind wall 132, likely to penetrate into the space between the wall and the IR camera, for example in the optical path between the porthole and the IR camera, the stray light rays being likely to generate a ghost image on image sensor 214.

According to an alternative example, the second end may be shaped to engage with the housing 212 of the IR camera, or with both lens mount 219 and housing 212.

Thus, interface element 230 enables to accurately position the infrared camera with respect the porthole, that is, to set the distance between the camera and the porthole in the direction of optical axis A (horizontal direction X in the shown example), but also the distance between the optical axis A of the infrared camera and the refracted optical axis B of the porthole in a direction perpendicular to optical axis A (vertical direction Z in the shown example). In the example of FIG. 2A, the optical axis A of camera 210 coincides with the refracted optical axis B of porthole 132. In the examples of FIGS. 2B and 2C, described hereafter, the optical axis A of the camera is offset by a distance D with respect to the refracted optical axis B of porthole 132 in the vertical direction Z.

In the shown example, interface element 230 is an element separate from wall 130 and from infrared camera 210. This enables to ease the replacing of the different elements of the wall and/or of the IR imaging device, for example in the event of a maintenance, or when the interface element has to be changed to be able to place the infrared camera behind a different wall or behind an identical wall with a different angle of inclination, or when the wall has to be replaced, for example if it has been damaged during its use.

According to an advantageous example, interface element 230 is capable of providing a fluid-tight sealing between porthole mount 134 and IR camera 210. This enables to decrease variations of the composition of the gas, for example air, in the space between the porthole and the IR camera and contained in said interface element. For example, this may enable to decrease humidity, particles, and/or dust in said space, so as to provide the most constant possible image quality, or at least to limit image quality variations. For example, the space between the porthole and the IR camera may be saturated with nitrogen, with a low concentration of particles and/or dust, before being enclosed in the interface element.

According to an example, at least a first inner surface of the interface element is based on a material absorbing in the spectral range of use of the IR camera or is covered with a coating absorbing in said spectral range.

According to an example, at least a second inner surface of the interface element is based on a material reflective in the spectral range of use of the IR camera, for example metallic, or is covered with a coating reflective in said spectral range, for example a metal coating.

According to an example, the interface element comprises at least a first inner surface based on a material absorbing in the spectral range of use of the IR camera or covered with a coating absorbing in said spectral range, and at least one second inner surface based on a material reflective in said spectral range, for example metallic, or covered with a coating reflective in said spectral range, for example a metal coating.

The first and second surfaces are for example defined according to an exposure to a stray light radiation and/or according to a temperature gradient likely to impact them.

According to an example, all or part of the inner surfaces 238 of interface element 230 is shaped to limit the emission of stray light radiation by said interface element towards the camera, for example, the inclined inner surfaces facing the camera are decreased or even excluded.

According to an example, the interface element comprises, inside of said element, at least one structure adapted to limiting the emission of stray light radiation by said interface element towards the camera, for example a structure of screen, mask, and/or light trap type. It may be a structure (or structures) regularly arranged around the optical axis in the interface element, or structures irregularly arranged around the optical axis in the interface element.

According to an example, the interface element is made of a material having a low thermal conduction, for example a thermal conduction lower than 10 W·m⁻¹·K⁻¹. This enables to favor the thermal insulation between the porthole and the IR camera. Indeed, the environment around the porthole may be submitted to temperature variations, particularly according to the conditions outside the wall, or the temperature variations may degrade the performance of the infrared camera, particularly by generating a stray heat flux. For example, when the wall is a portion of an enclosure capable of being thermally regulated, the combination of the thermal regulation in the enclosure and of the thermal insulation by the interface element enables to obtain an improved performance of the infrared camera.

According to an example, interface element 230 is provided with at least one temperature probe 240. A temperature probe may preferably be arranged inside of said interface element, but may also be arranged outside of said interface element. For example, a plurality of temperature probes may be positioned at different locations of the interface element to be able to determine a temperature gradient. For example, one or a plurality of temperature probes may be positioned in the vicinity of porthole 132 so as to estimate a temperature of the porthole, and/or one or a plurality of temperature probes may be positioned in the vicinity of the lens mount so as to estimate a lens temperature, and/or one or a plurality of temperature probes may be positioned on one or a plurality of inner surfaces of the interface element so as to estimate a value of emission of stray light radiation (stray light flux) by said surface (s).

According to an example, at least one temperature probe is coupled to a module for processing the stray light flux, that is, of the light flux captured by the infrared camera but originating from at least one source other than the image scene, for example a stray light flux emitted by the imaging device and/or the porthole. The module for processing the stray light flux may be included in or coupled to an image processing module in order to determine the light flux essentially originating from the image scene, for example by correcting it of the stray light flux.

Alternatively, all or part of the stray light flux may be determined without a temperature probe, and thus simplify the IR imaging device. Examples of means adapted to determining a stray light flux with no temperature probe are described in the following description, in relation with FIGS. 2B and 2C.

FIG. 2B is a cross-section view of a variant of the example of IR imaging device of FIG. 2A. The device 201 of FIG. 2B differs from the device 200 of FIG. 2A mainly in that:
the optical axis A of the camera is offset by a distance D with respect to the refracted optical axis B of the porthole in vertical direction Z; and
the first end 232 of interface element 230 comprises an inner surface 231 facing infrared camera 210 and positioned against an edge of porthole mount 134. Inner surface 231 is emitting, for example it is covered with an emissive coating 233; the emissive coating enables the surface thus covered to be more efficiently captured by the infrared camera.

Inner emitting surface 231 is shown in a lower portion of first end 232, but this is a non-limiting example. Alternatively, the inner emitting surface may be in another portion of first end 232 and/or be another inner surface of interface element 230, for example another inner surface in the vicinity of the porthole when a stray light flux emitted by the porthole is to be determined and/or another inner surface of the interface element when a stray light flux emitted by the imaging device is to be determined. A plurality of inner emitting surfaces may be provided.

This is an example of a configuration enabling to intentionally degrade the vignetting over a region of the field of view of the infrared camera, preferably a region non-critical for the intended application, and to form an image of the inner surface of the interface element in front of said degraded region of the field of view. The temperature determined by the image sensor in this degraded region of the field of view can then be used in a stray light flux processing module.

FIG. 2C is a cross-section view of another variant of the example of IR imaging device of FIG. 2A. The device 202 of FIG. 2C differs from the device 200 of FIG. 2A in that:
the optical axis A of the camera is offset by a distance D with respect to the refracted optical axis B of the porthole in vertical direction Z; and
the first end 232 of interface element 230 comprises a portion 235 forming a screen of a region 133 of transparent element 132 with respect to infrared camera 210; portion 235 comprises an emitting surface facing infrared camera 210, for example covered with an emissive coating 237.

Portion 235 is shown as being an inward extension of first end 232, in an upper portion of said first end, but this is a non-limiting example. Alternatively, the portion forming a screen may be an extension of another portion of first end 232 and/or be positioned elsewhere in interface element 230, for example close to the porthole when a stray light flux emitted by the porthole is to be determined, or even not necessarily close to the porthole when a stray light flux emitted by the imaging device is to be determined. A plurality of screen portions may be provided.

This is another example of a configuration enabling to deliberately degrade the vignetting over a region of the field of view of the infrared camera, preferably a non-critical region for the intended application, and to form an image of the inner surface of the portion of the interface element with respect to said degraded region of the field of view. The temperature determined by the image sensor in this degraded region of the field of view can then be used in a stray light flux processing module.

In another example, infrared camera 214 may comprise a pixel array image sensor comprising image pixels and at least one angular pixel.

By angular pixel, there is meant a pixel for detecting a stray light flux, or a stray heat flux, which is a pixel having a field of view modified with respect to that of the image pixels of the pixel array, in order to favor the capture of stray heat flux. For example, each stray heat flux detection pixel is arranged to capture a larger portion of stray heat flux than each image pixel of the pixel array.

The angular pixel is adapted to capturing a stray light flux originating from an inner area of the interface element facing the image sensor and within the field of view of said angular pixel, for example an inner area positioned around the transparent element, the area being for example covered with an emissive coating.

Examples of an infrared camera with a stray heat flux detection pixel, of a method of calibration of such an infrared camera, and of a method of correction of an image captured by such an infrared camera are described in international patent applications WO2019234215A1 and WO2019234216A1, the contents of these application being incorporated herein by reference.

As compared with the solutions described in relation with FIGS. 2B and 2C, this avoids having to degrade the field of view of the camera, and in particular avoids having to degrade the vignetting.

FIG. 2D is a cross-section view of another variant of the example of IR imaging device of FIG. 2A. The device 203 of FIG. 2C differs from the device 200 of FIG. 2A mainly in that it comprises a removable shutter 242 adapted to shutting off infrared camera 210. Shutter 242 may be in the form of a shutter flap. Shutter 242 may be assembled with interface element 230. Preferably, shutter 242 is located close to the IR camera, that is, at a distance shorter than the hyperfocal distance of the IR camera. This enables to blur possible inhomogeneities of the shutter, in terms of infrared emission.

A uniform shutter for example enables to calibrate the camera, the shutter forming a uniform calibration image in front of the camera when it is closed.

The shutter may, for example, be covered with an emissive coating on a surface of the shutter located in front of the infrared camera.

According to an example, shutter 242 is in thermal contact with interface element 230: in this case, the calibration image is used to quantify the amount of stray flux emitted by interface element 230 in use.

The variants of FIGS. 2B to 2D may be combined with each other, as well as with one or a plurality of the examples given in relation with FIG. 2A.

As described in the description in relation with FIGS. 1A and 1B, the vignetting phenomenon worsens as the distance between the porthole and the IR camera increases, and it is thus advantageous to position the IR camera as close as possible to the porthole, within the limit of the spacing between the IR camera and the wall. As can be understood in FIGS. 1A and 1B, in the example where the wall is inclined by an angle between 0 and 90° with respect to the horizontal direction, when the upper portion of the lens mount comes into contact with the inclined wall, it is no longer possible to decrease the distance between the IR camera and the porthole.

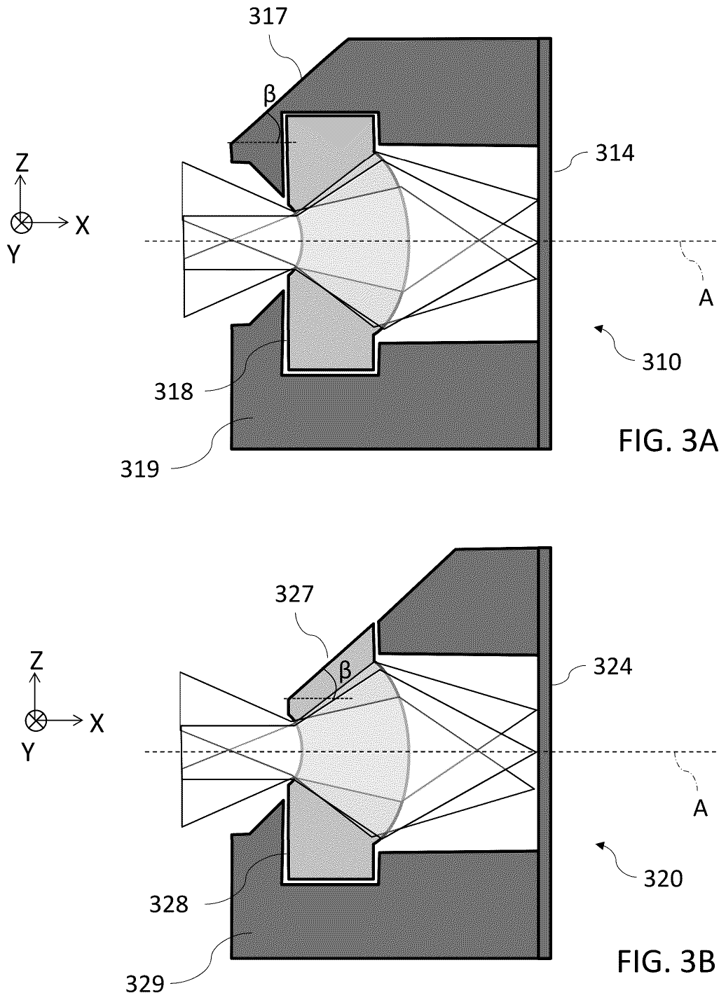

The inventors have thus thought of decreasing this distance by truncating the lens mount or even by truncating one or a plurality of lenses, as shown in FIGS. 3A and 3B.

FIG. 3A shows a variant of infrared camera 310 comprising an image sensor 314, similar to the image sensor described in relation with FIG. 2A, a plurality of lenses 318, and a lens mount 319 truncated according to a truncation angle β with respect to the optical axis A of the infrared camera. Truncation 317 is formed in a portion of the lens mount intended to face an inclined wall, here in the rear upper portion of the lens mount.

FIG. 3B shows another variant of infrared camera 320 comprising an image sensor 324, similar to the image sensor described in relation with FIG. 2A, a plurality of lenses including at least one lens 328 which is truncated according to a truncation angle R with respect to the optical axis A of the infrared camera, and a lens mount 329 also truncated with the same truncation angle β in continuity with the lens truncation. Truncation 327 is formed in a portion of the lens intended to face an inclined wall, here at the upper rear portion of the lens.

Preferably, the truncation of the lens is designed not to degrade the optical performance of the lens. According to an example, a truncated lens has at least one uneven (of free-form type) optical surface. The uneven optical surface is at least non-axisymmetric.

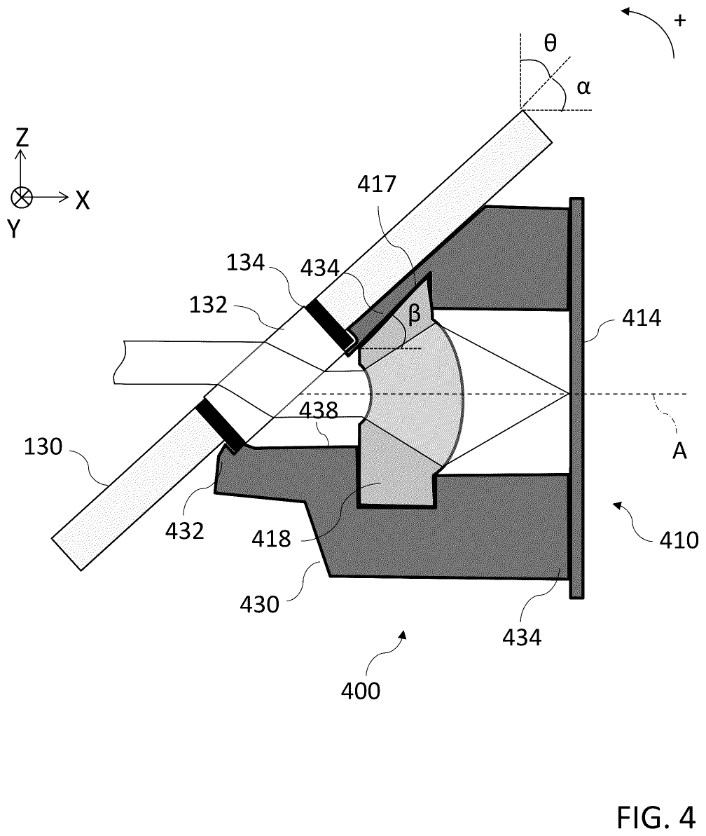

According to an advantageous example, the truncated lens is covered with a lens mount portion or with another covering part, adapted to covering the lens truncation. This enables to limit, or even to eliminate, a degradation of the optical performance of the truncated lens, for example when the truncated lens is submitted to temperature variations, and/or this enables to protect the environment close to the lens truncation from a stray light flux that may be induced by said truncation. FIG. 4 shows an example of a device in which the lens mount, which is also the interface element, is adapted to covering a lens truncation.

FIG. 4 shows another example of an IR imaging device 400 according to an embodiment, comprising an image sensor 414, similar to the image sensor described in relation with FIG. 2A, a plurality of lenses, including at least one lens 418 which is truncated according to a truncation angle β with respect to the optical axis A of the infrared camera. Device 400 further comprises an interface element 430 also forming a lens mount. In other words, interface element 430 and the lens mount form one piece. Further, interface element 430 comprises a covering portion 434, adapted to covering the lens truncation 417, and also adapted to being inserted between inclined wall 130 and said truncation.

According to an example, at least the covering portion 434, or even the entire interface element 430, is made of a material adapted to protecting lens truncation 417 from an external stray light flux, for example a reflective or absorbing material.

According to an example, at least covering portion 434, or even the entire interface element 430, is made of a material adapted to dissipating a stray heat flux.

Thus, the interface element 430 of FIG. 4 differs from that of FIG. 2A mainly in that it forms one piece with the lens mount and that it is adapted to a lens truncation. The enables to bring the infrared camera closer to the porthole, and thus to decrease the vignetting. This further enables to have a single part, for example compact, thus limiting clearances between parts, and enabling a more accurate positioning between the infrared camera and the inclined porthole.

Similarly to the interface element 230 of FIG. 2A, the interface element 430 of device 400 comprises a first end 432 shaped to engaged with porthole mount 134 by shape complementarity with said mount, thus assembling to the wall around the porthole. The second end 434 of the interface element is adapted to being assembled with image sensor 414, generally with a housing integrating the image sensor and the window between the sensor and the lenses. The other examples given in the description of FIG. 2A concerning the interface element may apply to the interface element 430 of FIG. 4.

In the shown example, truncation angle β is substantially equal to the angle of inclination α of the wall, which enables to bring the infrared camera as close as possible to the porthole.

Various embodiments and variants have been described. Those skilled in the art will understand that certain features of these various embodiments and variants may be combined, and other variants will occur to those skilled in the art. In particular, all the embodiments may be carried out with or without an offset between the optical axis of the infrared camera and the refracted optical axis. Further, in the embodiments, the image sensor housing and the lens mount may form one piece.

Finally, the practical implementation of the described embodiments and variants is within the abilities of those skilled in the art based on the functional indications given hereabove.

1. Infrared imaging device comprising an infrared camera having an optical axis and intended to detect an infrared radiation in a spectral range through an element transparent to said infrared radiation, said transparent element comprising two surfaces, an entrance surface and an exit surface, substantially planar and parallel to each other, and being surrounded by a mount, the transparent element with the mount being adapted to being inserted in an opening of a wall, the transparent element and at least a portion of the wall having the transparent element inserted therein being inclined by an angle of inclination (α) greater than 0° and smaller than 90° or smaller than 0° and greater than −90° with respect to the optical axis (A) of the infrared camera; the device further comprising:
an interface element adapted to forming an interface between the infrared camera and the mount.

2. Device according to claim 1, at least one inner surface of the interface element being shaped so as to decrease the emission of infrared radiation by said interface element towards the camera, and/or being made of a material adapted to decreasing the emission of infrared radiation by said interface element towards the camera and/or being covered with a coating adapted to decreasing the emission of infrared radiation by said interface element towards the camera.

3. Device according to claim 1, the interface element comprising a first end adapted to engaging with the mount of the transparent element by shape complementarity with said mount.

4. Device according to claim 1, the interface element comprising a second end adapted to engaging with the infrared camera by shape complementarity with at least a portion of said infrared camera.

5. Device according to claim 4, the infrared camera comprising at least one lens and a lens mount, said at least one lens being held by said lens mount, the second end of the interface element being adapted to engaging with the lens mount by shape complementarity with said lens mount.

6. Device according to claim 4, the infrared camera comprising at least one lens and a lens mount, said at least one lens being held by said lens mount, the interface element and the lens mount forming one piece.

7. Device according to claim 1, the infrared camera comprising at least one lens and a lens mount, said at least one lens being held by said lens mount, at least one lens and/or the lens mount comprising a truncated surface adapted to being positioned in front of the wall.

8. Device according to claim 7, the truncation angle (β) of the truncated surface with respect to the optical axis (A) of the infrared camera being substantially equal to the angle of inclination (α) of the wall and of the transparent element.

9. Device according to claim 7, the interface element comprising at least a portion adapted to covering the truncated face forming a thermal protection of the truncated face and/or a protection of said truncated face from infrared radiation.

10. Device according to claim 1, the infrared camera comprising:
at least one lens and a lens mount, said at least one lens being held by said lens mount; and
an image sensor sensitive to the infrared radiation of the spectral range;
the sensor and the at least one lens defining the optical axis (A) of the infrared camera, the sensor being arranged substantially in the image focal plane of said at least one lens.

11. Device according to claim 1, the interface element being adapted to providing a fluid-tight assembly between the wall and the infrared camera.

12. Device according to claim 1, the interface element being made of a material having al thermal conduction lower than 10 W·m⁻¹·K⁻¹.

13. Device according to claim 1, the interface element being provided with at least one temperature probe coupled to a module for processing a stray light flux emitted by the device.

14. Device according to claim 1, comprising a removable shutter element adapted to shutting off the infrared camera, said shutter element being covered with an emissive coating on a surface of said shutter element facing the infrared camera.

15. Device according to claim 1, the interface element comprising an inner emitting surface facing the infrared camera and adapted to being positioned against the mount of the transparent element, said inner emitting surface being covered with an emissive coating.

16. Device according to claim 1, the interface element comprising a portion adapted to being positioned in front of a region of the transparent element so as to form a screen between said region of the transparent element and the infrared camera, said portion comprising an emitting surface facing the infrared camera covered with an emissive coating.

17. Device according to claim 1, the infrared camera comprising an image sensor with a pixel array comprising an angular pixel adapted to capturing a light flux originating from an inner area of the interface element facing the image sensor and the field of view of the angular pixel, said inner area being covered with an emissive coating.

18. Infrared imaging system comprising:
an infrared imaging device according to claim 1, and
a wall comprising an opening having an element transparent to the infrared radiation of a spectral range, surrounded by with a mount, inserted therein;
the infrared camera of the device being adapted to detecting an infrared radiation of the spectral range through the transparent element;
the transparent element and at least a portion of the wall having the transparent element inserted therein being inclined by an angle of inclination (α) greater than 0° and smaller than 90° or smaller than 0° and greater than −90° with respect to the optical axis (A) of the camera.

19. Infrared imaging device according to claim 1, wherein the transparent element is included in the volume corresponding to the opening of the wall, and/or does not protrude laterally on either side of the opening of the wall.
